(19) United States
(12) Patent Application Publication
(10) Pub. No.: US 2006/0246285 A1
(43) Pub. Date: Nov. 2, 2006

(54) Process for the production of cellulosic moulded bodies

(76) Inventors: Josef Schmidtbauer, Vocklabruck (AT); Harald Schobesberger, Ohlsdorf (AT)

Correspondence Address: FITZPATRICK CELLA HARPER & SCINTO, 30 ROCKEFELLER PLAZA, NEW YORK, NY, 10112, US

(21) Appl. No.: 11/368,102

(22) Filed: Mar. 3, 2006

Related U.S. Application Data
(63) Continuation of application No. PCT/AT04/00297, filed on Sep. 1, 2004.

(30) Foreign Application Priority Data
Sep. 1, 2003 (AT) A 1402/2003

(51) Int. Cl. D01F 2/02; D03D 15/00; D01F 2/00; D01F 6/04; D04B 21/00; D04H 13/00; D02G 3/00; F16J 15/20

(52) U.S. Cl. 428/365; 264/187; 264/203; 442/304; 442/327; 442/181; 428/364

(57) ABSTRACT

The invention relates to a method for producing cellulose moulded bodies according to the viscose method, the bodies containing a material with ion-exchanging characteristics, which is added to the spinning dope and/or to a precursor thereof. The inventive method is characterized in that the material is added in the form of a dispersion of particles with a maximum grain size of 20 μm or less.

### CROSS-REFERENCE TO RELATED APPLICATIONS

This application is a continuation of International Patent Application No. PCT/AT2004/00297, filed Sep. 1, 2004, which claims priority to Austrian Patent Application No. A 1402/2003, filed Sep. 5, 2003, both of which are incorporated by reference in their entireties.

### BACKGROUND OF THE INVENTION

### Field of the Invention

The invention relates to a process for the production of cellulosic moulded bodies according to the viscose process.

The production of moulded bodies according to the viscose process, in particular of viscose fibres, has been conducted on a commercial scale for many decades and comprises the following steps:
Alkalization of a cellulose starting material such as, for example, pulp
Conversion of the alkalized cellulose starting material (“alkali cellulose”) into cellulose xanthogenate
Dissolution of the cellulose xanthogenate with alkali. The solution thus obtained is referred to as “viscose”.
Spinning of the viscose into moulded bodies in one or several regeneration baths
Regeneration of the cellulose from the moulded bodies and aftertreatment of the moulded bodies obtained

For instance, washing, drying and, in case of viscose fibres, e.g., the finish as well as—for the production of staple fibres—the cutting of the fibres belong to the steps of aftertreatment.

The viscose process serves in particular for the production of fibres (staple fibres and filament fibres) and films but also for the production of other products such as sponges or cellulose particles.

Viscose fibres are divided into two groups: so-called “standard viscose fibres” and so-called “modal fibres” wherein higher strengths and higher wet moduli are achieved by specific means during the manufacture of the viscose and during spinning. The two groups have been classified as generic terms by BISFA (The International Bureau for the Standardisation of Man Made Fibres). (In said classification, standard viscose fibres are referred to as “viscose”. For a better distinction from the term “viscose” which is also used for spinning dope, the term “standard viscose fibre” is used in the present application).

It is known to modify moulded bodies, in particular fibres, produced according to the viscose process with certain functional groups in order to thus improve, for example, the colourability of the moulded bodies or their absorbing capacity.

In this context, it is also known to modify moulded bodies produced according to the viscose process with materials having ion-exchange properties. In this way, moulded bodies are obtained which themselves have ion-exchange properties. Such moulded bodies, in particular in the form of fibres, are better suited for numerous fields of application than conventional ion-exchange materials.

The modification of the moulded bodies can be achieved by applying the functional groups onto the already extruded moulded body (e.g., by grafting). Another method consists in adding the functional groups to the spinning dope or to a precursor of the spinning dope, for example, to the pulp that is used or to the alkalized cellulose, prior to the conversion into cellulose xanthogenate.

WO 96/37641 describes a process for the production of a viscose fibre, wherein, among other things, a polymeric styrene sulfonic acid is added to the viscose mass or alkali cellulose.

From JP-A 61-146810, it is known to produce viscose fibres by admixing solutions of polystyrene sulfonates or polystyrene carboxylates, respectively, as well as salts thereof into a viscose and spinning fibres thereupon. The purpose of the process is the production of fibres with an improved behaviour towards cationic dyes.

JP-A 3-54234 discloses the manufacture of regenerated cellulose comprising portions of ionic polymer compounds. The compounds are mixed into the viscose. The moulded bodies produced exhibit ion-exchange and also antimicrobial properties.

From GB-A 910,202, a process for the production of a membrane or of a film, respectively, according to the viscose process is known, wherein materials having ion-exchange properties are likewise used.

From DE-A 199 17 614, a process for the production of cellulosic moulded bodies according to the amine-oxide process is known, wherein ion-exchange particles are added to a solution of cellulose in an amine oxide. In technological terms, the amine-oxide process differs fundamentally from the viscose process.

In the documents known with respect to the viscose process, wherein a material having ion-exchange properties is added to the viscose and/or to a precursor thereof, the material is always added in the form of a solution.

It has been shown that the processes for the modification of moulded bodies as known from the prior art leave a lot to be desired especially in terms of their spinning yield, since polymer solutions cannot be embedded quantitatively in the cellulose matrix due to their consistency. Components that have been embedded incompletely cause undesired accumulations in the process cycle and must be removed in a complex manner.

It is the object of the present invention to provide an improved process for the production of such moulded bodies as well as improved moulded bodies having ion-exchange properties.

The object is achieved by means of a process for the production of cellulosic moulded bodies according to the viscose process, which moulded bodies contain a material having ion-exchange properties, wherein the material having ion-exchange properties is added to the spinning dope and/or to a precursor thereof, which process is characterized in that the material is added in the form of a dispersion of particles having a maximum grain size of 20 μm or less.

Preferably, the material having ion-exchange properties is added in the form of an aqueous dispersion.

It has been shown that the admixture of a dispersion to the viscose or to a precursor thereof, respectively, results in far higher spinning yields of 99% and more, in contrast to the admixture of a solution as known from the prior art. Such spinning yields would not be achievable with the use of liquid polymers or solutions.

Thereby, it is important that the maximum grain size of the particles present in the dispersion is low and especially does not exceed 20 μm. Preferably, the particles have a maximum grain size of 7 μm or less.

For the purposes of the present invention and the patent claims, the term “maximum grain size” thereby means that 99% of the particles in the dispersion have at most the respective grain size as indicated in each case.

Conventional viscoses usable for the production of moulded bodies, in particular those which are usable for the production of standard viscose fibres or modal fibres, are suitable as spinning dope. The production of the moulded bodies from the spinning dope as well as the aftertreatment of the moulded bodies is carried out according to conventional methods known per se to a person skilled in the art.

Preferably, fibres in the form of staple fibres or (continuous) filament fibres but also films, sponges and cellulose particles are manufactured by the process according to the invention. Standard viscose fibres or modal fibres can be produced.

If a material exhibiting strong acid cation-exchange properties is used as the material having ion-exchange properties, the sulfonic acid group is suitable as a functional group.

If a material having weak acid cation-exchange properties is used, carbonic acid, phosphonic acid, methacrylic acid, iminodiacetic acid, thiourea and thiol groups as well as further chelate-forming groups are suitable as functional groups.

Materials comprising amphoteric groups are also suitable for use in the process according to the invention.

In case of a material having cation-exchange properties, a preferred embodiment of the process according to the invention consists in that the moulded body containing the material is treated with a metal ion preferably selected from the group consisting of silver, lead, copper, zinc and mercury ions.

The metal ions are thereby bound to the active groups of the material having cation-exchange properties. In this way, the moulded body can, for example, be given antibacterial properties.

In a particularly preferred embodiment of this variant of the process according to the invention, the functional groups of the material are converted at least partially into the zinc form prior to spinning and/or in the regeneration bath.

Via a conversion into the zinc form prior to spinning, it is prevented, on the one hand, that the Zn-ions present in the regeneration bath and necessary for the regeneration are absorbed by the extruded moulded body as a result of ion-exchange effects.

On the other hand, it is possible to deliberately utilize the ion-exchange effects of the extruded moulded body to the effect that the moulded bodies in the regeneration bath are allowed to have zinc ions bind to them. Zinc ions have antibacterial activity in the finished moulded body.

If a material exhibiting strong base anion-exchange properties is used as the material having ion-exchange properties, the quaternary ammonium group is suitable as a functional group.

If a material having weak base anion-exchange properties is used, secondary and tertiary amine groups are suitable as functional groups.

Preferably, the material having ion-exchange properties exhibits, in a manner known per se, a matrix (on which the functional groups are located) selected from cross-linked polystyrene or copolymers from polystyrene and methacrylic acid, polyacrylate, polyacrylamide, phenol/formaldehyde and/or cellulose.

In sum, commercially available ion-exchange resins conventional per se and selected from the group of
strong acid cation exchangers
weak acid cation exchangers
weak base anion exchangers
strong base anion exchangers
specific or chelate ion exchangers
as well as all combinations thereof
   can be used in the process according to the invention.

Thereby, the material having ion-exchange properties can be used in an amount of from 0.1 to 100% by weight, preferably from 10 to 70% by weight, particularly preferably from 10 to 50% by weight, based on cellulose and based on the dry active substance.

The dispersion that is used can exhibit a concentration of material having ion-exchange properties of from 1 to 60% by weight, preferably from 20 to 50% by weight, again based on the dry active substance.

The present invention also relates to a cellulosic moulded body obtainable by the process according to the invention. Preferably, the moulded body according to the invention is provided in the form of a fibre, a film, a sponge and/or a particle.

The moulded bodies according to the invention have numerous advantages over ion-exchange materials known per se:
The facts are that the ions to be separated turn out to be able apparently to infiltrate the cellulose matrix of the moulded body and are adsorbed there by the resin particles. Thus, a combination of two principles of action, namely that of ion exchange as well as that of the separation of solid particles, can be achieved when using the moulded bodies according to the invention.
A more favourable ion-exchange kinetics is observed, whereby diluted solutions can be treated in a more efficient way.
The capacity can be utilized better by up to 40% in comparison with conventional ion exchangers based on resin.
Higher throughput rates are achieved.
The moulded bodies according to the invention are resistant to pressure, compact and can be regenerated easily.
A lower chemical consumption is achieved.
The moulded bodies according to the invention can be disposed of in an environmentally friendly way.
In the preferred embodiment according to which the moulded bodies exhibit bound metal ions, in particular zinc ions, the moulded bodies have further favourable, for example antibacterial properties.

Furthermore, the present invention relates to a fibre mixture which comprises a cellulosic moulded body according to the invention in the form of a cellulosic fibre.

The cellulosic fibre according to the invention can thereby be mixed with natural and chemical fibres, in particular with cotton, viscose, modal, lyocell, polyester and/or polyamide, in system or intimate mixtures. The amount of the fibre according to the invention in the mixture can range from 1% to 99%, preferably from 20% to 70%.

Another aspect of the present invention is a textile article, in particular a yarn, woven fabric, knitted fabric and/or non-woven fabric which comprises the cellulosic fibre according to the invention or a fibre mixture according to the invention.

Non-woven fabrics according to the invention can, for example, be manufactured according to the methods known per se of needling, thermobonding, water-jet solidification and/or chemical solidification.

The present invention also relates to the use of the cellulosic moulded body according to the invention, of the fibre mixture according to the invention and/or of the textile article according to the invention in liquid filters, for waste water purification and for the purification of solutions, for the separation of heavy metals, for desalination, in air filters having antibacterial properties, as an antibacterial material, in particular as a starting material for medical textiles, for analytical purposes, in particular as a substrate for preparative and catalytic applications in analytics, for example in a chromatographic separation, and/or for products having antibacterial properties, in particular for underwear, sportswear, socks, hospital textiles, bed linen, household cloths, terry cloth goods and sanitary non-woven fabrics.

As mentioned above, it is important that the grain size of the material having ion-exchange properties is sufficiently small in the dispersion.

Therefore, commercially available ion exchangers which normally are provided in the form of resin balls having a grain size of 0.4-1.5 mm have to be processed into a fine dispersion. For this purpose, grinding of the material has to be carried out in water, using special fine grinders, whereby it may be necessary to coarsely crush the balls.

Grinding preferably takes place in a bead stirring mill whose beads consist of ZrO₂ and have a size of typically 1.1 to 1.4 mm or of 0.7 to 0.9 mm. It is at any time possible for a person skilled in the art to choose the appropriate bead size. On the one hand, this depends on the particle size of the unground product; on the other hand, it is impossible to generate fine particle sizes in the dispersion using milling balls which are too large.

The bead stirring mill can be operated in a cyclic operation mode. Beforehand, coarse crushing can be effected, e.g., using an Ultra-Turrax or a toothed colloid mill.

The resulting dispersion is stabilized with dispersing agents and thickening agents in a manner known per se. Especially polyphosphates, polyacrylic acid derivatives or alkylene oxide polymers have turned out to be suitable dispersing agents and thickening agents, and xanthane rubber has turned out to be a suitable thickening agent.

Preferred products are, for example,

Calgon N (polyphosphate), manufacturer: Messrs. BK Giulini Chemie

Lopon 890 (sodium polyacrylate), manufacturer: Messrs. BK Giulini Chemie

Hydropalat 890 (alkylene oxide polymer), manufacturer: Messrs.

Henkel/Cognis

Deuteron VT819 (xanthane rubber), manufacturer: Messrs. Henkel/Cognis.

The addition of the dispersion to the spinning dope can be effected either by stirring the dispersion into the viscose with a stirrer or by continuously metering and homogenizing the dispersion into the feed line of the so-called “spinning pipe” by means of which the spinning dope is supplied to the moulding tool, e.g., to the die. A conventional plastic filter having a mesh width of 20 μm is sufficient for filtering the viscose.

In case of the production of fibres, the dies which are used can have a slightly larger hole diameter than for the production of unmodified fibres. If the resins are ground to a sufficient degree of fineness (for example smaller than 5 em), the hole diameter normally does not have to be chosen larger, however. Apart from that, the production parameters (such as the composition of regeneration baths) which are common for the production of unmodified fibres can be used.

In the following, the invention is illustrated in further detail by way of exemplary embodiments, wherein, however, those examples may by no means be construed as limiting.

### EXAMPLES

### Example 1

The ion-exchange resin Lewatit MP S100 (strong acid cation exchanger comprising sulfonic acid groups in Na⁺ form, based on polystyrene, gelatinous, size of initial beads: approx. 600 μm) is dispersed in water at equal weight percentages and coarsely crushed with the aid of a colloid mill. The water used already contains wetting and dispersing agents (0.1% Calgon N, 0.3% Lopon 890). A 24% suspension is formed, which is ground in a cyclic operation to a fine dispersion by means of a bead mill (size of milling balls: 1.1 to 1.4 mm), with further additives (0.1% Deuteron VT819, 0.3% Hydropalat 1080) being added. The maximum grain size of the dispersion amounts to 4.9 μm.

The dispersion is mixed with an 8.65% aqueous viscose solution used for the production of standard viscose fibres at a dispersion:viscose weight ratio=1:6. In this way, a resin content in the fibre of 31% by weight is achieved. The mixture is spun from dies having a diameter of 80 μm into a spinning bath. The spinning bath contains about 100 g/l H₂SO₄, 350 g/l Na₂SO₄, and 17 g/l ZnSO₄ at 48° C. In order to obtain an appropriate fibre strength, a stretching of about 75% is performed in the secondary bath (92° C., 15 g/l H₂SO₄). The takeoff speed is 50 m/min.

The filaments obtained are cut into staples of 40 mm, treated with acidulous water in a conventional manner, desulfurized, bleached as required, washed and brightened. Drying takes place at 70° C.

The fibres obtained have a titre of 4.4 dtex and a dry strength of 12 cN/tex at an elongation of 24%.

The total capacity of the fibres was determined to be 2.2 mequ/g fibres according to DIN 54403.

### Example 2

The same procedure as in Example 1 is used, however, the dispersion is stirred into a 6% viscose used for the production of modal fibres at a dispersion:viscose weight ratio=1:8.7. In this way, a resin content in the fibre of 31% by weight is likewise achieved.

The mixture is spun from dies having a diameter of 80 μm into a spinning bath. The spinning bath contains about 80 g/l H₂SO₄, 115 g/l Na₂SO₄, and 60 g/l ZnSO₄ at 40° C. In order to obtain an appropriate fibre strength, a second-bath stretching (92° C., 15 g/l H₂SO₄) of about 114% is effected. The take-off speed is 25 m/min.

The filaments obtained are cut into staples of 40 mm, treated with acidulous water, desulfurized, bleached as required, washed and brightened. Drying takes place at 70° C.

The fibres obtained have a titre of 3.6 dtex and a dry strength of 19 cN/tex at an elongation of 17%.

The total capacity of the fibres was determined to be 2.1 mequ/g fibres according to DIN 54403.

### Example 3

The production of viscose fibres is performed as described in Example 1. However, the maximum grain size of the dispersion used is 7 μm and the tows are stretched by 55%.

The fibres obtained have a titre of 2.9 dtex and a dry strength of 9 cN/tex at an elongation of 13%.

The total capacity of the fibres was determined to be 1.35 mequ/g fibres.

Due to the ion-exchange property, the zinc present in the spinning bath and necessary for the production of viscose fibres is partially bound to the fibre. A zinc concentration on the fibre of 2770 ppm was measured.

The bound zinc produces an antimicrobial effect. Bacteriostatic as well as bacteriocidal activities against Staphylococcus aureus and Klebsiella pneumoniae have been detected (JIS L 1902: Testing Method for antibacterial of textiles, 1998).

### Example 4

Instead of the ion-exchange resin quoted under Example 1, the ion-exchange resin Lewatit TP 208 (weak acid chelate ion exchanger comprising methylene iminodiacetic acid groups in Na⁺-form, based on polystyrene, size of initial beads: approx. 700 μm) was used.

The resin is dispersed in water at equal weight percentages and coarsely crushed with the aid of an Ultra-Turrax. The water already contains wetting and dispersing agents (0.1% Calgon N, 0.3% Lopol 890). A 20% suspension is formed, which is ground in a cyclic operation to a fine dispersion by means of a bead mill (size of milling balls: 1.1 to 1.4 mm). The maximum grain size of the dispersion amounts to 7.7 μm.

The dispersion is mixed with a 6% viscose used for the production of modal fibres at a dispersion:viscose weight ratio=1:12. In this way, a resin content in the fibre of 22% by weight is achieved. The mixture is spun from dies having a diameter of 90 μm into a spinning bath. The spinning bath contains about 80 g/lH₂SO₄, 115 g/l Na₂SO₄, and 60 g/l ZnSO₄ at 40° C. In order to obtain an appropriate fibre strength, a stretching of about 99% is performed in the secondary bath (92° C., 15 g/l H₂SO₄). The take-off speed is 25 m/min.

The filaments obtained are cut into staples of 40 mm, treated with acidulous water, desulfurized, bleached as required, washed and brightened. Drying takes place at 70° C.

The fibres obtained have a titre of 2.3 dtex and a dry strength of 21 cN/tex at an elongation of 14%.

The total capacity of the fibres was determined to be 1.35 mequ/g fibres according to DIN 54403.

### Example 5

The anion-exchange resin Lewatit MP 500 (macroporous strong base anion exchanger comprising quaternary ammonium groups in C1⁻ form, based on polystyrene, size of initial beads: approx. 600 μm) is at first pretreated with diluted viscose, filtered off and subsequently dispersed in water at equal weight percentages. The water used already contains wetting and dispersing agents (0.1% Calgon N, 0.3% Lopol 890). Coarse crushing is effected with the aid of an Ultra-Turrax. A 18% suspension is formed, which is ground in a cyclic operation to a fine dispersion by means of a bead mill (size of milling balls: 1.1 to 1.4 mm), with further additives (0.1% Deuteron VT819, 0.3% Hydropalat 1080) being added. The maximum grain size of the dispersion amounts to 9 μm.

The dispersion having a solid content of 18% is mixed with a 8.65% aqueous viscose solution (viscose for standard viscose fibres) at a dispersion:viscose weight ratio=1:33. In this way, a resin content in the fibre of 5.9% by weight is achieved. The mixture is spun from dies having a diameter of 90 μm into a spinning bath. The spinning bath contains about 100 g/l H₂SO₄, 350 g/lNa₂SO₄, and 17 g/l ZnSO₄ at 58° C. In order to obtain an appropriate fibre strength, a stretching of about 75% is performed in the secondary bath (92° C., 15 g/l H₂SO₄). The take-off speed is 50 m/min.

The filaments obtained are cut into staples of 40 mm, treated with acidulous water, desulfurized, washed and brightened. Drying takes place at 70° C.

The fibres obtained have a titre of 6.7 dtex and a dry strength of 9.9 cN/tex at an elongation of 16.7%. The total capacity of the fibres was determined to be 0.08 mequ/g fibres.

### Example 6

The ion-exchange resin Lewatit MP S 100 is dispersed in water at equal weight percentages and coarsely crushed with the aid of a colloid mill. 0.1% Calgon N, 0.3% Lopon 890, 0.1% Deuteron VT819 and 0.3% Hydropalat 1080 are added as additives.

A 24% suspension is formed, which is ground in a cyclic operation to a fine dispersion by means of a bead mill. The maximum grain size of the dispersion amounts to 7.8 μm.

The dispersion is mixed with a 8.65% aqueous viscose solution at a dispersion:viscose weight ratio=1:69. In this way, a resin content in the fibre of 3.8% by weight is achieved. The mixture is spun from dies having a diameter of 80 mm into a spinning bath. The spinning bath contains about 100 g/lH₂SO₄, 350 g/lNa₂SO₄, and 17 g/l ZnSO₄ at 48° C. In order to obtain an appropriate fibre strength, a stretching of 69% is performed in the secondary bath (92° C., 15 g/lH₂SO₄). The take-off speed is 50 m/min.

The filaments obtained therefrom are cut into staples of 40 mm, treated with acidulous water, desulfurized, bleached as required, washed and brightened. Drying takes place at 70° C.

The fibres have a titre of 3.5 dtex and a dry strength of 22.4 cN/tex at an elongation of 15.5%. The total capacity of the fibres was determined to be 0.34 mequ/g fibres according to DIN 54403.

Due to the regeneration in a spinning bath containing zinc, the fibre has a zinc concentration of 910 ppm Zn. The bound zinc enhances the antibacterial effect. Bacteriostatic as well as bacteriocidal activities against Staphylococcus aureus and Klebsiella pneumoniae have been detected (JIS L 1902: Testing method for antibacterial of textiles, 1998).

### Examples 7 and 8

According to the process described in Example 2, the ion-exchange resins Duolite C467 (weak acid chelate ion exchanger comprising aminophosphonic acid groups in Na⁺ form, based on polystyrene, macroporous) and Amberlite GT73 (weak acid cation exchanger comprising thiol groups in H⁺ form, based on polystyrene, macroporous, size of initial beads: 0.45-0.7 mm) were incorporated in modal fibres. In the following table, the most important results are summarized.

| | Example 7 | Example 8 |
|---|---|---|
| Resin used | Duolite C467 | Amberlite GT73 |
| Amount of ion exchanger | 30% | 24% |
| in fibre | | |
| Maximum grain size | 3.00 μm | 5.22 μm |
| Titre of fibre | 3.45 dtex | 3.3 dtex |
| Fibre strength | 9.8 cN/tex | 9.6 cN/tex |
| Fibre elongation | 15.3% | 18.2% |
| Exchange capacity | 1.47 meq/g | 0.52 meq/g |

### Example 9

The ion-exchange resin Lewatit MP62 (polystyrene, weakly basic, tertiary amine, macroporous) is coarsely crushed in deionized water at equal weight percentages by means of an Ultra-Turrax, and the resulting mixture is ground to a fine dispersion with a maximum grain size of 10.16 μm and a solid content of 20.9% with the aid of a bead mill (size of milling balls: 1.1-1.4 mm). In this example, the dispersion was produced without the use of dispersing agents.

The dispersion is mixed with a 6% viscose used for the production of modal fibres at a dispersion:viscose weight ratio of 1:3.5. The mixture is spun from dies having a diameter of 80 μm into a spinning bath. The spinning bath contains about 80 g/l H₂SO₄, 115 g/lNa₂SO₄ and 60 g/l ZnSO₄ at 40° C. In order to obtain an appropriate fibre strength, a stretching of 82% is performed in the secondary bath (92° C., 15 g/l H₂SO₄). The take-off speed is 25 m/min.

The filaments obtained therefrom are cut into staples of 40 mm, rewashed in the acidic state, desulfurized, bleached, washed and dried at 60° C.

The fibres have a titre of 4.8 dtex and a dry strength of 6.14 cN/tex at an elongation of 35.6%. The total capacity of the fibres was determined to be 2.0 mequ/g according to DIN 54403 and corresponds to the resin content in the fibre of 50%.

### Example 10 (Comparative Example)

The ion-exchange resin Lewatit MonoPlus S100 (polystyrene, strongly acidic, sodium sulfonate, macroporous) is coarsely crushed in deionized water at equal weight percentages by means of an Ultra-Turrax, and the resulting mixture is ground to a grain size of 26 μm and a solid content of 18.3% with the aid of a bead mill (size of milling balls: 1.1-1.4 mm). In order to improve spinnability, the dispersion contains 0.1% Calgon N and 0.3% Lopol 890.

The dispersion is mixed with a 6% viscose used for the production of modal fibres at a dispersion:viscose weight ratio of 1:10. The mixture is spun from dies having a diameter of 80 μm into a spinning bath. The spinning bath contains about 80 g/l H₂SO₄, 115 g/l Na₂SO₄ and 60 g/l ZnSO₄ at 40° C.

In doing so, within 10 min, a pressure increase of 10 bar is observed at the die filter, which pressure increase renders impossible a controlled fibre production.

### Example 11

Starting from the ion-exchange resin Lewatit MonoPlus S100 already described, fibres having a resin content of 2.1% were produced in analogy to Example 9 and subsequently treated shortly with a zinc sulfate solution (0.5 mol/l) or with a silver nitrate solution (0.5 mol/l), respectively. Thereby, a full exploitation of the capacity was not strived for.

After washing out the excess solution with deionized water and drying the fibres at 60° C., zinc and silver concentrations of 3100 ppm and 15000 ppm, respectively, could be detected in the fibres via ICP analysis. Both fibre samples exhibit a pronounced antibacterial activity against Staphylococcus aureus and Kiebsiella pneumoniae (JIS L 1902).

What is claimed is:

1. A process for the production of cellulosic moulded bodies according to the viscose process, which moulded bodies contain a material having cation-exchange properties, wherein the material having cation-exchange properties is added to a spinning dope and/or to a precursor thereof, wherein the material has functional groups selected from the group consisting of sulfonic acid, carbonic acid, phosphonic acid, aminophosphonic acid, iminodiacetic acid, thiourea, thiol, chelate-forming, amphoteric groups, and mixtures thereof, and is added in the form of a dispersion of particles having a maximum grain size of 20 μm or less.

2. A process according to claim 1, wherein the material is added in the form of an aqueous dispersion.

3. A process according to claim 1, wherein the particles have a maximum grain size of 7 μm or less.

4. A process according to claim 2, wherein the particles have a maximum grain size of 7 μm or less.

5. A process according to claim 1, wherein the moulded body containing the material is treated with a metal ion selected from the group consisting of silver, lead, copper, zinc and mercury ions.

6. A process according to claim 5, wherein the functional groups of the material are converted at least partially into a zinc form prior to spinning and/or in a regeneration bath.

7. A process according to claim 1, wherein the material exhibits a matrix selected from the group consisting of cross-linked polystyrene or copolymers from polystyrene and methacrylic acid, polyacrylate, polyacrylamide, phenol/formaldehyde, cellulose, and mixtures thereof.

8. A process according to claim 1, wherein the material is used in an amount of from 0.1 to 100% by weight, based on cellulose and based on a dry active substance.

9. A process according to claim 1, wherein the dispersion exhibits a concentration of material having ion-exchange properties of from 1 to 60% by weight, based on a dry active substance.

10. A cellulosic moulded body, obtainable by a process according to claim 1.

11. A cellulosic moulded body according to claim 10 in the form of a fibre, a film, a sponge and/or a particle.

12. A fibre mixture, comprising a cellulosic fibre according to claim 11.

13. A textile article selected from the group consisting of yarn, woven fabric, knitted fabric, non-woven fabric, and mixtures thereof comprising a cellulosic fibre according to claim 11.

14. A textile article selected from the group consisting of yarn, woven fabric, knitted fabric, non-woven fabric, and mixtures thereof comprising a fibre mixture according to claim 12.

15. Use of the cellulosic moulded body according to claim 10,
in liquid filters, for waste water purification and for the purification of solutions, for the separation of heavy metals, for desalination, in air filters having antibacterial properties,
as an antibacterial material,
for analytical purposes, and
for other products having antibacterial properties.

16. Use of the cellulosic moulded body according to claim 11,
in liquid filters, for waste water purification and for the purification of solutions, for the separation of heavy metals, for desalination, in air filters having antibacterial properties,
as an antibacterial material,
for analytical purposes, and
for other products having antibacterial properties.

17. Use of the fibre mixture according to claim 12,
in liquid filters, for waste water purification and for the purification of solutions, for the separation of heavy metals, for desalination, in air filters having antibacterial properties,
as an antibacterial material,
for analytical purposes, and
for other products having antibacterial properties.

18. Use of the textile article according to claim 13,
in liquid filters, for waste water purification and for the purification of solutions, for the separation of heavy metals, for desalination, in air filters having antibacterial properties,
as an antibacterial material,
for analytical purposes, and
for other products having antibacterial properties.
